(19) United States
(12) Patent Application Publication
(10) Pub. No.: US 2026/0061362 A1
(43) Pub. Date: Mar. 5, 2026

(54) ACID GAS RECOVERY SYSTEM

(71) Applicant: MITSUBISHI HEAVY INDUSTRIES, LTD., Tokyo (JP)

(72) Inventors: Shintaro Honjo, Tokyo (JP); Osamu Miyamoto, Tokyo (JP); Takashi Kamijo, Tokyo (JP); Yoshiaki Arakawa, Tokyo (JP); Hiromitsu Nagayasu, Tokyo (JP); Yukio Tanaka, Tokyo (JP)

(73) Assignee: MITSUBISHI HEAVY INDUSTRIES, LTD., Tokyo (JP)

(21) Appl. No.: 18/816,592

(22) Filed: Aug. 27, 2024

(51) Int. Cl. B01D 53/14; B01D 15/08; B01D 17/04; B01D 51/10; B01D 53/04; B01D 53/18; B01D 53/26

(52) U.S. Cl. CPC B01D 53/1437; B01D 15/08; B01D 17/042; B01D 17/045; B01D 51/10; B01D 53/04; B01D 53/1406; B01D 53/1425; B01D 53/1475; B01D 53/18; B01D 53/265; B01D 2252/103; B01D 2253/102; B01D 2257/504; B01D 2257/702; B01D 2257/80

(57) ABSTRACT

An acidic gas recovery system includes a cooling tower into which a target gas of treatment containing an acidic gas is introduced to cool the target gas of treatment; an inlet adsorption device that is configured to bring the target gas of treatment cooled in the cooling tower into contact with activated carbon to remove hydrocarbons remaining in the target gas of treatment; an absorption tower that is configured to discharge the absorbent liquid which has absorbed the acidic gas and an absorption tower discharge gas containing the target gas of treatment from which the acidic gas is removed; and a regeneration tower that is configured to discharge the absorbent liquid from which the acidic gas is released and a regeneration tower discharge gas containing the acidic gas.

### BACKGROUND OF THE INVENTION

### Field of the Invention

The present disclosure relates to an acidic gas recovery system.

### Description of Related Art

In recent years, from the viewpoint of carbon neutrality, attention is paid to a concentration of carbon dioxide (CO₂) contained in the atmosphere. From the viewpoint of reducing the concentration of carbon dioxide in the atmosphere, a carbon dioxide recovery system that recovers carbon dioxide from exhaust gas is known. In the carbon dioxide recovery system, an absorbent liquid circulates between a regeneration tower and an absorption tower, and carbon dioxide is recovered from exhaust gas.

For example, Patent Document 1 describes a carbon dioxide recovery device (CO₂ recovery device) capable of filtering solid contents such as soot and fly ash remaining in an absorbent liquid that removes carbon dioxide in exhaust gas. The carbon dioxide recovery system includes an absorption tower that absorbs carbon dioxide with a CO₂ absorbent liquid, and a regeneration tower that removes carbon dioxide from the CO₂ absorbent liquid and returns the carbon dioxide to the absorption tower.

### CITATION LIST

### Patent Document

[Patent Document 1] Japanese Patent No. 6216259

### SUMMARY OF THE INVENTION

By the way, in a system that recovers an acidic gas, such as the above-described carbon dioxide recovery system, hydrocarbons, which contain a trace amount of polycyclic aromatic hydrocarbons (PAHs) and have a high boiling point, may be included as impurities contained in a target gas of treatment such as exhaust gas. In a case where such hydrocarbons are incorporated into a liquid, the hydrocarbons circulate in the system of the recovery system together with an absorbent liquid. As a result, hydrocarbons are accumulated in the circulating absorbent liquid. In a case where the hydrocarbons are accumulated in the absorbent liquid, the hydrocarbons may be solidified in the absorbent liquid and precipitated in a flowing process and may block a pipeline and a device. Therefore, it is desired to suppress the mixing of hydrocarbons into the absorbent liquid.

In addition, in a case where an amine aqueous solution or the like is used as the CO₂ absorbent liquid, there is a problem in that a deteriorated product generated with the passage of time in the operation is accumulated in the system of the recovery system or a part of the deteriorated product is discharged as VOC to the atmosphere from the absorption tower of the CO₂ recovery system or discharged from the regeneration tower, thereby lowering the product CO₂ purity.

The present disclosure is made in order to solve the above-described problem, and an object of the present disclosure is to provide an acidic gas recovery system capable of efficiently suppressing the mixing of hydrocarbons into an absorbent liquid or the accumulation of a deteriorated product in the absorbent liquid.

In order to solve the above-described problem, an acidic gas recovery system according to an aspect of the present disclosure includes a cooling tower into which a target gas of treatment containing an acidic gas as a recovery target gas is introduced to cool the target gas of treatment; an inlet adsorption device that is configured to bring the target gas of treatment cooled in the cooling tower into contact with activated carbon to remove hydrocarbons remaining in the target gas of treatment; an absorption tower into which the target gas of treatment from which the hydrocarbons are removed by the inlet adsorption device is introduced, and that is configured to bring the target gas of treatment into contact with an absorbent liquid to discharge the absorbent liquid which has absorbed the acidic gas and an absorption tower discharge gas containing the target gas of treatment from which the acidic gas is removed; and a regeneration tower that is configured to release the acidic gas from the absorbent liquid discharged from the absorption tower to discharge the absorbent liquid from which the acidic gas is released and a regeneration tower discharge gas containing the acidic gas.

An acidic gas recovery system according to another aspect of the present disclosure includes an absorption tower into which a target gas of treatment containing an acidic gas as a recovery target gas is introduced, and that is configured to bring the target gas of treatment into contact with an absorbent liquid to discharge the absorbent liquid which has absorbed the acidic gas and an absorption tower discharge gas containing the target gas of treatment from which the acidic gas is removed; a regeneration tower that is configured to release the acidic gas from the absorbent liquid discharged from the absorption tower to discharge the absorbent liquid from which the acidic gas is released and a regeneration tower discharge gas containing the acidic gas; a gas-liquid separator that is configured to separate moisture contained in the regeneration tower discharge gas discharged from the regeneration tower to discharge separated discharge gas from which the moisture is separated and supply the separated moisture to the regeneration tower as drain water; a dewatering device that is configured to absorb the moisture contained in the regeneration tower discharge gas discharged from the regeneration tower; and a drain water adsorption device that is configured to bring the drain water supplied from at least one of the gas-liquid separator and the dewatering device to the regeneration tower into contact with activated carbon to remove hydrocarbons remaining in the drain water.

An acidic gas recovery system according to still another aspect of the present disclosure includes an absorption tower into which a target gas of treatment containing an acidic gas as a recovery target gas is introduced, and that is configured to bring the target gas of treatment into contact with an absorbent liquid to discharge the absorbent liquid which has absorbed the acidic gas and an absorption tower discharge gas containing the target gas of treatment from which the acidic gas is removed; a regeneration tower that is configured to release the acidic gas from the absorbent liquid discharged from the absorption tower to discharge the absorbent liquid from which the acidic gas is released and a regeneration tower discharge gas containing the acidic gas; a dewatering device that is configured to absorb moisture contained in the regeneration tower discharge gas discharged from the regeneration tower; and an outlet adsorption device that is configured to bring the regeneration tower discharge gas from which the moisture is removed in the dewatering device into contact with activated carbon to remove hydrocarbons remaining in the regeneration tower discharge gas.

According to the acidic gas recovery system of the present disclosure, it is possible to efficiently suppress the mixing of hydrocarbons into an absorbent liquid or the accumulation of a deteriorated product in the absorbent liquid.

### BRIEF DESCRIPTION OF THE DRAWINGS

FIG. 1 is a schematic view showing a carbon dioxide recovery system according to a first embodiment.

FIG. 2 is a schematic view showing a carbon dioxide recovery system according to a second embodiment.

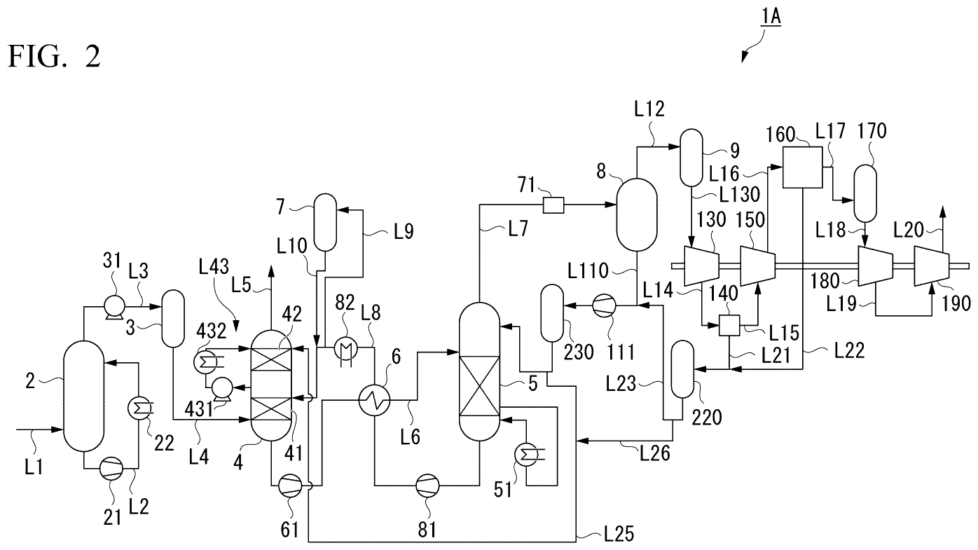

FIG. 3 is a schematic view showing a carbon dioxide recovery system according to a third embodiment.

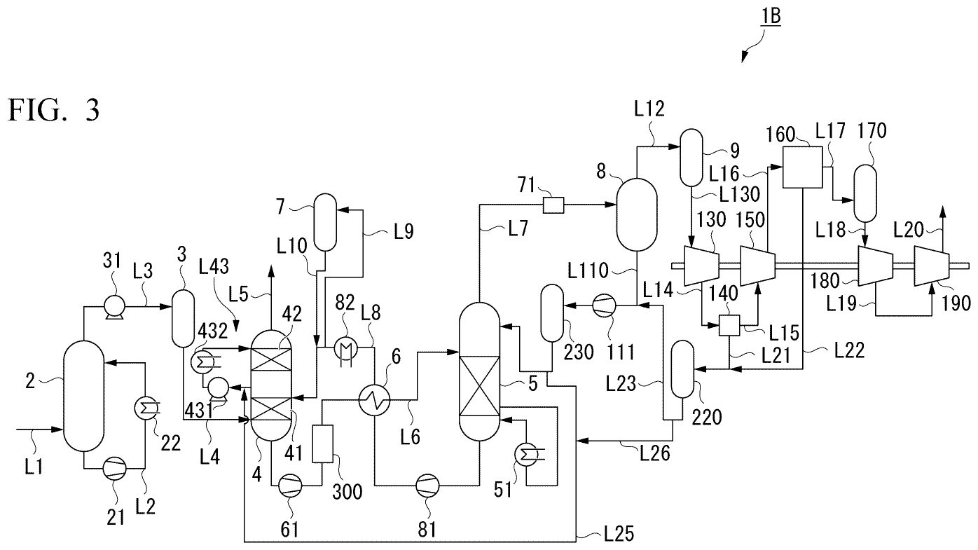

FIG. 4 is a schematic view showing a carbon dioxide recovery system according to a modification example.

### DETAILED DESCRIPTION OF THE INVENTION

Hereinafter, a form for carrying out an acidic gas recovery system according to the present disclosure will be described with reference to the accompanying drawings.

However, the present disclosure is not limited only to the embodiment.

### First Embodiment

### Carbon Dioxide Recovery System

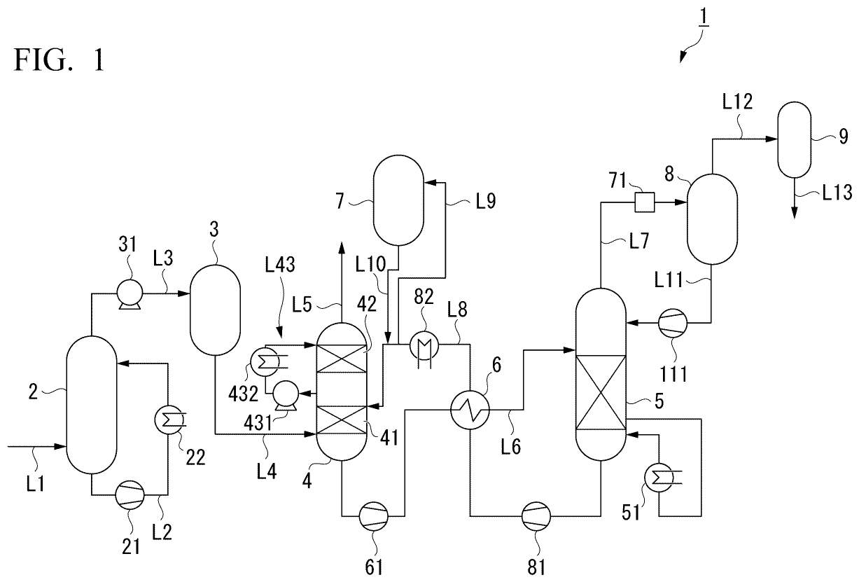

A carbon dioxide recovery system (acidic gas recovery system) 1 is a facility that performs treatment to recover an acidic gas from a target gas of treatment from a gas generation source (not shown). As shown in FIG. 1, the carbon dioxide recovery system 1 of the present embodiment separates and recovers carbon dioxide contained in a target gas of treatment using an absorbent liquid, and can supply the recovered carbon dioxide to another device. For example, the gas generation source includes a waste incineration furnace, a coal or natural gas-fired power generation plant, a gas turbine, a gas engine, a cement plant, an iron manufacturing plant, a glass melting plant, and an ethanol manufacturing plant, and the like. The target gas of treatment from the gas generation source includes a recovery target gas, ash, heavy metals, hydrocarbons, and the like. The recovery target gas includes, in addition to carbon dioxide (CO2), nitrogen oxides (NOₓ) such as nitrogen monoxide (NO), sulfur oxides (SOₓ) such as sulfur dioxide (SO2), and acidic gases such as hydrogen sulfide (H2S). In the present embodiment, carbon dioxide will be described as an example of the recovery target gas. In addition, the gas generation source may be equipment that is outside the carbon dioxide recovery system 1 and that sends the atmosphere to the carbon dioxide recovery system 1. That is, the carbon dioxide recovery system 1 performs treatment on the exhaust gas discharged from various facilities or the atmosphere as a target gas of treatment.

The absorbent liquid is preferably a high-concentration solution in order to improve the absorbance of the acidic gas and lower the regeneration energy. In a case of absorbing carbon dioxide, for example, the absorbent liquid is preferably an amine aqueous solution or a non-aqueous amine solution in which a physical absorption solvent is applied instead of water. As the amine absorbent liquid, specifically, for example, an alkanolamine such as monoethanolamine (MEA), diethanolamine (DEA), triethanolamine (TEA), methyldiethanolamine (MDEA), diisopropanolamine (DIPA), or diglycolamine (DGA) can be employed. In addition, hindered amines can also be employed. In addition, each of the single aqueous solutions or a mixed aqueous solution of two or more of these aqueous solutions can also be adopted.

The carbon dioxide recovery system 1 of the present embodiment includes a supply line L1, a cooling tower 2, a supply cooling circulation line L2, a cooler discharge line L3, an inlet adsorption device 3, an inlet adsorption line L4, an absorption tower 4, an absorption tower discharge line L5, a rich line L6, a regeneration tower 5, a lean line L8, a regeneration tower discharge gas line L7, an absorbent liquid heat exchanger 6, a lean liquid adsorption supply line L9, a lean liquid adsorption device 7, a lean liquid adsorption discharge line L10, a gas-liquid separator 8, a drain return line L11, a separated discharge gas line L12, a first outlet adsorption device 9, and a first removal line L13.

The supply line L1 sends a part of the target gas of treatment containing carbon dioxide generated in the gas generation source to the cooling tower 2. The supply line L1 is a pipeline that connects together the gas generation source and the cooling tower 2.

### Cooling Tower

A target gas of treatment containing carbon dioxide as a recovery target gas is introduced into the cooling tower 2 via the supply line L1. In addition, cooled water (for example, drain water) is introduced into the cooling tower 2 via the supply cooling circulation line L2. The cooling tower 2 cools the target gas of treatment by bringing the introduced target gas of treatment into contact with water. The target gas of treatment cooled in the cooling tower 2 is sent to the cooler discharge line L3. In the cooling tower 2, the temperature of the target gas of treatment is cooled from 100° C. to 200° C. to 40° C. to 50° C. In addition, the cooling tower 2 cools the target gas of treatment and sends the heated water to the supply cooling circulation line L2.

The supply cooling circulation line L2 circulates the water heated in the cooling tower 2 such that the water is cooled and sent to the cooling tower 2 again. The supply cooling circulation line L2 has a supply circulation pump 21 and a supply circulation cooler 22 in the middle. The supply circulation pump 21 pressurizes the water discharged from the cooling tower 2 and sends the water to the cooling tower 2 via the supply circulation cooler 22. The supply circulation cooler 22 cools the supplied water by exchanging heat with the cooling liquid.

The cooler discharge line L3 sends the target gas of treatment cooled by the cooling tower 2 to the inlet adsorption device 3 via a supply blower 31. The cooler discharge line L3 is a pipeline that connects together the cooling tower 2 and the inlet adsorption device 3.

The supply blower 31 is disposed in the middle of the cooler discharge line L3. The supply blower 31 increases the flow rate of the target gas of treatment cooled by the cooling tower 2 and supplies the target gas of treatment to the inlet adsorption device 3. Specifically, the supply blower 31 can pressurize the target gas of treatment flowing through the cooler discharge line L3. The supply blower 31 increases the temperature of the target gas of treatment to be introduced into the inlet adsorption device 3 and an absorber by pressurizing the target gas of treatment flowing through the cooler discharge line L3. The supply blower 31 can change the pressure increase rate of the target gas of treatment.

### Inlet Adsorption Device

The inlet adsorption device 3 brings the target gas of treatment cooled by the cooling tower 2 into contact with activated carbon to remove hydrocarbons remaining in the target gas of treatment. The inlet adsorption device 3 of the present embodiment adsorbs hydrocarbons having a high boiling point, which contain a trace amount of Polycyclic Aromatic Hydrocarbons (PAHs), to activated carbon, and thus the hydrocarbons can be removed from the target gas of treatment. The target gas of treatment that is cooled and pressurized is introduced into the inlet adsorption device 3 via the cooler discharge line L3. The inlet adsorption device 3 sends the target gas of treatment from which the hydrocarbons are removed to the inlet adsorption line L4. In the inlet adsorption device 3, for example, a tank extending in the vertical direction is filled with activated carbon, and the target gas of treatment can flow in the tank.

The inlet adsorption line L4 sends the target gas of treatment from which the hydrocarbons are removed by the inlet adsorption device 3 to the absorption tower 4.

The inlet adsorption line L4 is a pipeline that connects together the inlet adsorption device 3 and the absorption tower 4.

Absorption Tower

The target gas of treatment containing carbon dioxide is introduced into the absorption tower 4 via an inlet adsorption line L4. The target gas of treatment from which hydrocarbons are removed by the inlet adsorption device 3 is introduced into the absorption tower 4. The absorption tower 4 brings a target gas of treatment into contact with the absorbent liquid to remove carbon dioxide from the target gas of treatment. The absorption tower 4 separately discharges an absorbent liquid in which carbon dioxide is absorbed and an absorption tower discharge gas containing a target gas of treatment from which carbon dioxide is removed. In addition, the absorbent liquid from which carbon dioxide is released in the regeneration tower 5 is introduced into absorption tower 4 via the lean line L8. The absorption tower 4 of the present embodiment has a recovery section 41, a water washing section 42, and an absorption tower circulation line L43.

The recovery section 41 brings the target gas of treatment into contact with the absorbent liquid. The recovery section 41 causes the absorbent liquid to recover the carbon dioxide. A nozzle (not shown) that ejects the absorbent liquid downward in the vertical direction is disposed in the recovery section 41. As a result, in the recovery section 41, the target gas of treatment upward in the vertical direction and the absorbent liquid downward in the vertical direction are in countercurrent contact with each other, and carbon dioxide in the target gas of treatment is absorbed by the absorbent liquid.

The water washing section 42 brings the decarbonized gas after being brought into contact with the absorbent liquid in the recovery section 41 into contact with washing water. The water washing section 42 recovers absorbent liquid components accompanied in the decarbonized gas. The water washing section 42 is disposed above the recovery section 41 in the vertical direction. A nozzle (not shown) that ejects washing water downward in the vertical direction is disposed in the water washing section 42. As a result, in the water washing section 42, the decarbonized gas upward in the vertical direction and the washing water downward in the vertical direction come into countercurrent contact with each other. As a result, the water washing section 42 cools the decarbonized gas and recovers the absorbent liquid component with the washing water.

The absorption tower circulation line L43 circulates the condensed water containing the washing water or the absorbent liquid used in the water washing section 42 to return to the nozzle of the water washing section. The absorption tower circulation line L43 recovers the condensed water generated in the water washing section 42 from between the water washing section 42 and the recovery section 41 in the vertical direction. An absorption tower circulation pump 431 and an absorption tower circulation heat exchanger 432 are disposed in the absorption tower circulation line L43. The absorption tower circulation pump 431 pressurizes the condensed water and sends the pressurized condensed water to the nozzle of the water washing section 42. The absorption tower circulation heat exchanger 432 cools the supplied condensed water and sends the cooled condensed water to the nozzle of the water washing section 42.

The absorption tower discharge line L5 discharges the absorption tower discharge gas discharged from the absorption tower 4 to the outside. That is, the absorption tower discharge line L5 discharges the absorption tower discharge gas to the outside of the carbon dioxide recovery system 1. The absorption tower discharge line L5 is connected to the top portion of the absorption tower 4.

The rich line L6 supplies the absorbent liquid in which carbon dioxide is absorbed from the absorption tower 4 to the regeneration tower 5. Here, the absorbent liquid that is discharged from the absorption tower 4 and flows through the rich line L6 is referred to as a rich liquid. The rich liquid is an absorbent liquid having a high concentration of carbon dioxide after carbon dioxide is absorbed in the absorption tower 4. The rich line L6 connects together the bottom portion of the absorption tower 4 and the upper portion of the regeneration tower 5. A rich pump 61 is disposed in the rich line L6. The rich pump 61 pressurizes the rich liquid and sends the pressurized rich liquid to the regeneration tower 5 via the absorbent liquid heat exchanger 6.

### Regeneration Tower

The rich liquid is introduced into the regeneration tower 5 via the rich line L6. The regeneration tower 5 releases the carbon dioxide from the rich liquid which is the absorbent liquid discharged from the absorption tower 4. The regeneration tower 5 heats the rich liquid by the reboiler 51. As a result, in the regeneration tower 5, most of the carbon dioxide is released from the rich liquid together with the vapor, and the carbon dioxide is separated from the rich liquid. High-temperature steam is supplied to the reboiler 51. In the reboiler 51, the absorbent liquid is heated by performing heat exchange between the steam and the absorbent liquid. The regeneration tower 5 separately discharges the absorbent liquid from which carbon dioxide is released and the regeneration tower discharge gas containing the carbon dioxide. The regeneration tower 5 sends the absorbent liquid from which the carbon dioxide is released to the lean line L8. The regeneration tower 5 sends a regeneration tower discharge gas containing the carbon dioxide to the regeneration tower discharge gas line L7.

The lean line L8 supplies the absorbent liquid from which the carbon dioxide is released from the regeneration tower 5 to the absorption tower 4. Here, the absorbent liquid discharged from the regeneration tower 5 and flowing through the lean line L8 is referred to as a lean liquid. The lean liquid is an absorbent liquid having a low concentration of the carbon dioxide after the carbon dioxide is released in the regeneration tower 5. That is, the lean liquid has a lower concentration of carbon dioxide than the rich liquid. The lean line L8 connects together the bottom portion of the regeneration tower 5 and the recovery section 41 of the absorption tower 4. A lean pump 81 and a lean cooler 82 are disposed in the lean line L8. The lean pump 81 pressurizes the lean liquid and sends the pressurized lean liquid to the absorption tower 4 via the absorbent liquid heat exchanger 6. The lean cooler 82 further cools the absorbent liquid cooled by the absorbent liquid heat exchanger 6 and sends the cooled absorbent liquid to the absorption tower 4.

### Absorbent Liquid Heat Exchanger

The absorbent liquid heat exchanger 6 performs heat exchange between the rich liquid flowing through the rich line L6 and the lean liquid flowing through the lean line L8. As a result, in the absorbent liquid heat exchanger 6, the rich liquid flowing through the rich line L6 in a state of being pressurized by the rich pump 61 from the absorption tower 4 to the regeneration tower 5 is heated. At the same time, in the absorbent liquid heat exchanger 6, the lean liquid flowing through the lean line L8 in a state of being pressurized by the lean pump 81 from the regeneration tower 5 to the absorption tower 4 is cooled.

The lean liquid adsorption supply line L9 sends a part of the lean liquid cooled by the absorbent liquid heat exchanger 6 to the lean liquid adsorption device 7. The lean liquid adsorption supply line L9 is connected to the lean line L8 between the absorbent liquid heat exchanger 6 and the absorption tower 4. The lean liquid adsorption supply line L9 is a pipeline that connects together the lean line L8 and the lean liquid adsorption device 7.

The lean liquid adsorption device 7 brings a part of the lean liquid cooled by the absorbent liquid heat exchanger 6 into contact with activated carbon to remove hydrocarbons remaining in the lean liquid. The lean liquid adsorption device 7 of the present embodiment adsorbs hydrocarbons having a high boiling point, which contain Polycyclic Aromatic Hydrocarbons (PAHs), to activated carbon, and thus the hydrocarbons can be removed from the lean liquid. A part of the lean liquid cooled by the absorbent liquid heat exchanger 6 is introduced into the lean liquid adsorption device 7 via the lean liquid adsorption supply line L9. The lean liquid adsorption device 7 sends the lean liquid from which the hydrocarbons are removed to the lean liquid adsorption discharge line L10. In the lean liquid adsorption device 7, for example, a tank extending in the vertical direction is filled with activated carbon, and the lean liquid can flow in the tank.

The lean liquid adsorption discharge line L10 sends the lean liquid from which the hydrocarbons are removed by the lean liquid adsorption device 7 to the lean line L8. The lean liquid adsorption discharge line L10 is connected to the lean line L8 between a connection position of the lean liquid adsorption supply line L9 and the lean line L8 and the absorption tower 4. Therefore, the lean liquid adsorption discharge line L10 returns a part of the lean liquid removed from the lean line L8 by the lean liquid adsorption supply line L9 to the lean line L8. The lean liquid adsorption discharge line L10 is a pipeline that connects together the lean line L8 and the lean liquid adsorption device 7.

The regeneration tower discharge gas line L7 supplies the regeneration tower discharge gas discharged from the regeneration tower 5 to the gas-liquid separator 8. The regeneration tower discharge gas line L7 is connected to the top portion of the regeneration tower 5. The regeneration tower discharge gas line L7 is a pipeline that connects together the regeneration tower 5 and the gas-liquid separator 8. The regeneration tower discharge gas line L7 has a regeneration tower discharge gas condenser 71 in the middle thereof. The regeneration tower discharge gas condenser 71 cools the regeneration tower discharge gas discharged from the regeneration tower 5 to condense the moisture into a liquid.

### Gas-Liquid Separator

The gas-liquid separator 8 separates the moisture contained in the regeneration tower discharge gas discharged from the regeneration tower 5. The gas-liquid separator 8 discharges separated discharge gas in which moisture is separated, and supplies the separated moisture as separated drain water to the regeneration tower 5. That is, the separated drain water is drain water discharged from the gas-liquid separator 8. The gas-liquid separator 8 of the present embodiment recovers the moisture generated by being condensed in the regeneration tower discharge gas condenser 71. The moisture recovered by the gas-liquid separator 8 is discharged to the drain return line L11 as separated drain water. The gas-liquid separator 8 discharges the separated discharge gas to a separated discharge gas line L12.

The drain return line L11 supplies the separated drain water discharged from the gas-liquid separator 8 to the regeneration tower 5. The drain return line L11 is a pipeline that connects together the gas-liquid separator 8 and the regeneration tower 5. A drain return pump 111 is disposed in the drain return line L11. The drain return pump 111 pressurizes the separated drain water and sends the pressurized drain water to the regeneration tower 5.

The separated discharge gas line L12 supplies the separated discharge gas discharged from the gas-liquid separator 8 to the first outlet adsorption device 9. The separated discharge gas line L12 is a pipeline that connects together the gas-liquid separator 8 and the first outlet adsorption device 9.

### First Outlet Adsorption Device

The first outlet adsorption device 9 brings the regeneration tower discharge gas discharged from the regeneration tower 5 into contact with activated carbon to remove hydrocarbons remaining in the regeneration tower discharge gas. The first outlet adsorption device 9 of the present embodiment brings the separated discharge gas, from which the moisture is separated by the gas-liquid separator 8, into contact with the activated carbon to remove the hydrocarbons remaining in the separated discharge gas. The first outlet adsorption device 9 adsorbs hydrocarbons having a high boiling point, which contain Polycyclic Aromatic Hydrocarbons (PAHs), to activated carbon, and thus the hydrocarbons can be removed from the separated discharge gas. The separated discharge gas is introduced into the first outlet adsorption device 9 via the separated discharge gas line L12. The first outlet adsorption device 9 sends the separated discharge gas from which the hydrocarbons are removed to the first removal line L13. In the first outlet adsorption device 9, for example, a tank extending in the vertical direction is filled with activated carbon, and the separated discharge gas can flow in the tank.

The first removal line L13 discharges the separated discharge gas from which the hydrocarbons are removed from the first outlet adsorption device 9. The first removal line L13 of the present embodiment transfers the separated discharge gas from which hydrocarbons are removed, for example, to an external transfer destination according to the purpose of use. The separated discharge gas, which is discharged from the first removal line L13 and from which the hydrocarbons are removed, is transferred to, for example, a state according to the purpose of use and is stored by a tank, a lorry, a pipeline, the inside of an oil field, an aquifer, or the like.

### Operation and Effect

In the carbon dioxide recovery system 1 having the above-described configuration, the target gas of treatment cooled by the cooling tower 2 is supplied to the inlet adsorption device 3 via the cooler discharge line L3, comes into contact with activated carbon, and is removed of hydrocarbons. That is, the hydrocarbons are removed from the target gas of treatment before being supplied to the absorption tower 4 by the inlet adsorption device 3. Therefore, it is possible to suppress the inflow of hydrocarbons including polycyclic aromatic hydrocarbons into the absorption tower 4. Further, in the inlet adsorption device 3, hydrocarbons are removed from the target gas of treatment after being cooled in the cooling tower 2. In the target gas of treatment after being cooled in the cooling tower 2, not only the gas temperature is simply lowered, but also the moisture concentration and the impurity concentration are lowered as the gas temperature is lowered. Since activated carbon also adsorbs water, there is a disadvantage that the adsorption performance of hydrocarbons is lowered in a situation where the moisture concentration is high. In the inlet adsorption device 3 having the above-described configuration, since the moisture concentration is lowered, the target gas of treatment after being cooled has improved adsorption performance for hydrocarbons on activated carbon compared to the target gas of treatment before being cooled. As a result, the activated carbon is efficiently used for adsorption of hydrocarbons, and the mixing of hydrocarbons into the absorbent liquid can be efficiently suppressed. In addition, by disposing the inlet adsorption device 3 in the downstream of the supply blower 31, the relative humidity in the discharged exhaust gas in which the moisture of the cooling tower 2 is saturated is lowered, and the amount of moisture condensed in the activated carbon pores is reduced, so that the adsorption performance of the hydrocarbons can be improved.

In addition, in a case where hydrocarbons flow into the absorption tower 4, the hydrocarbons mixed into the absorbent liquid are solidified in the absorbent liquid in the process of flowing. As a result, the hydrocarbons may be precipitated in the flow passage, such as the rich line L6 and the lean line L8, or in the device such as the absorbent liquid heat exchanger 6, and thus the performance of various devices may be lowered. However, it is possible to suppress the mixing of hydrocarbons into the absorbent liquid, and the accumulation of hydrocarbons in the absorbent liquid can be reduced. As a result, it is possible to extend the operation time of the carbon dioxide recovery system 1 including the absorption tower 4.

In particular, in the present embodiment, in the cooling tower 2, the high-temperature target gas of treatment is cooled to 40° C. to 50° C. The adsorption efficiency of hydrocarbons from the target gas of treatment by the activated carbon is higher as the temperature is lower. Therefore, by supplying the target gas of treatment cooled to 40° C. to 50° C. in the cooling tower 2 to the inlet adsorption device 3, the adsorption performance of the activated carbon can be further improved. As a result, the mixing of hydrocarbons into the absorbent liquid can be more efficiently suppressed.

In addition, the gas temperature of the target gas of treatment after being cooled is lower than that of the target gas of treatment before being cooled, so that the gas volume (flow rate) is also lowered. Therefore, in the inlet adsorption device 3, the volume of the activated carbon in contact with the target gas of treatment can be reduced. That is, it is possible to reduce the size of the inlet adsorption device 3. Therefore, it is possible to efficiently suppress the mixing of hydrocarbons into the absorbent liquid with a small device configuration.

In addition, in the present embodiment, in the inlet adsorption device 3, the hydrocarbons are removed from the target gas of treatment pressurized by the supply blower 31. In a case where the target gas of treatment is compressed by the supply blower 31, the gas volume (flow rate) of the target gas of treatment is further lowered. Therefore, the volume of the activated carbon in contact with the target gas of treatment can be further reduced. Therefore, it is possible to further reduce the size of the inlet adsorption device 3.

In addition, the first outlet adsorption device 9 brings the separated discharge gas from which moisture is separated by the gas-liquid separator 8 into contact with activated carbon to remove the hydrocarbons remaining in the separated discharge gas. That is, the hydrocarbons are removed from the regeneration tower discharge gas discharged from the regeneration tower 5. Therefore, the inlet adsorption device 3 further removes the hydrocarbons from the regeneration tower discharge gas generated from the target gas of treatment in a state in which the hydrocarbons are already removed and reduced. Therefore, the purity of the regeneration tower discharge gas from which the carbon dioxide is removed can be increased. As a result, the quality of the gas from which carbon dioxide finally discharged from the carbon dioxide recovery system 1 is removed can be improved.

In particular, in the present embodiment, the regeneration tower discharge gas becomes the separated discharge gas in a state in which moisture is removed by the gas-liquid separator 8, and thereafter hydrocarbons are removed. That is, the separated discharge gas has a lower moisture concentration as compared to the regeneration tower discharge gas immediately after being discharged from the regeneration tower 5. In a case where the moisture concentration is low, the adsorption performance of the activated carbon can be improved. As a result, hydrocarbons can be efficiently removed from the separated discharge gas.

### Second Embodiment

Next, a carbon dioxide recovery system 1A according to a second embodiment of the present disclosure will be described. In the second embodiment described below, the same configurations as those in the first embodiment are denoted by the same reference numerals in the drawing, and descriptions thereof will be omitted. In the second embodiment, the carbon dioxide recovery system 1A is configured differently from the first embodiment at a position downstream of the first removal line.

In addition, the upstream and the downstream in the present embodiment are the upstream and the downstream in the flow direction of various gases and liquids flowing in the carbon dioxide recovery system 1A.

In the carbon dioxide recovery system 1A of the second embodiment, the separated discharge gas sent to a first removal line L130 is not discharged to the outside as it is. The separated discharge gas sent to the first removal line L130 is additionally subjected to a treatment such as compression, dewatering, or removal of hydrocarbons. The carbon dioxide recovery system 1A according to the second embodiment further includes a first compressor 130, a first compression line L14, a first dewatering device 140, a first dewatering line L15, a second compressor 150, a second compression line L16, a second dewatering device 160, a second dewatering line L17, a second outlet adsorption device 170, a second removal line L18, a third compressor 180, a third compression line L19, a fourth compressor 190, a fourth compression line L20, a first dewatering drain line L21, a second dewatering drain line L22, a dewatered drain water adsorption device 220, a separated drain water adsorption device 230, a dewatered drain water line L23, a first drain water return line L25, and a second drain water return line L26.

### First Compressor

The first compressor 130 compresses the separated discharge gas. The separated discharge gas from which hydrocarbons are removed is introduced into the first compressor 130 via a first removal line L130. The first compressor 130 is connected to the first outlet adsorption device 9 via the first removal line L130. The first compressor 130 discharges the separated discharge gas which is compressed.

The first compression line L14 can supply the separated discharge gas discharged from the first compressor 130 to the first dewatering device 140. The first compression line L14 is a pipeline that connects together the first compressor 130 and the first dewatering device 140.

### First Dewatering Device

The first dewatering device 140 can remove moisture from the separated discharge gas which is compressed. The separated discharge gas which is compressed through the first compression line L14 is introduced into the first dewatering device 140. The first dewatering device 140 performs, for example, glycol dewatering on the separated discharge gas which is compressed. The first dewatering device 140 absorbs and dewaters vapor from the separated discharge gas using, for example, a liquid drying agent. The first dewatering device 140 discharges first dewatered gas, which is separated discharge gas from which moisture is removed, and dewatered drain water which is the removed moisture (drain water).

The first dewatering line L15 can supply the first dewatered gas discharged from the first dewatering device 140 to the second compressor 150. The first dewatering line L15 is a pipeline that connects together the first dewatering device 140 and the second compressor 150.

### Second Compressor

The second compressor 150 compresses the first dewatered gas. The second compressor 150 is connected to the first dewatering device 140 via the first dewatering line L15. That is, the second compressor 150 further compresses the separated discharge gas after being compressed by the first compressor 130. In addition, the second compressor 150 is on the same shaft with the first compressor 130 (has a structure having an integrated rotor). The first dewatered gas is introduced into the second compressor 150 via the first dewatering line L15. The second compressor 150 discharges the first dewatered gas which is compressed.

The second compression line L16 can supply the first dewatered gas discharged from the second compressor 150 to the second dewatering device 160. The second compression line L16 is a pipeline that connects together the second compressor 150 and the second dewatering device 160.

### Second Dewatering Device

The second dewatering device 160 can remove moisture from the first dewatered gas which is compressed. The first dewatered gas compressed via the second compression line L16 is introduced into the second dewatering device 160. The second dewatering device 160 performs, for example, glycol dewatering on the separated discharge gas which is compressed again after being once dewatered. The second dewatering device 160 may have the same configuration as the first dewatering device 140 or may have a different configuration. The second dewatering device 160 absorbs and dewaters vapor from the separated discharge gas using, for example, a liquid drying agent. The second dewatering device 160 discharges second dewatered gas, which is the first dewatered gas from which the moisture is further removed, and dewatered drain water which is the removed moisture (drain water).

The second dewatering line L17 can supply the second dewatered gas discharged from the second dewatering device 160 to the second outlet adsorption device 170. The second dewatering line L17 is a pipeline that connects together the second dewatering device 160 and the second outlet adsorption device 170.

### Second Outlet Adsorption Device

The second outlet adsorption device 170 is a second outlet adsorption device that brings the regeneration tower discharge gas discharged from the regeneration tower 5 into contact with activated carbon to remove hydrocarbons remaining in the regeneration tower discharge gas. That is, the carbon dioxide recovery system 1A of the second embodiment includes a plurality of outlet adsorption devices. The second outlet adsorption device 170 of the present embodiment brings the second dewatered gas, which is the regeneration tower discharge gas from which the moisture is removed by the second dewatering device 160, into contact with the activated carbon to remove the hydrocarbons remaining in the second dewatered gas. Similarly to the first outlet adsorption device 9, the second outlet adsorption device 170 adsorbs hydrocarbons having a high boiling point, which contain Polycyclic Aromatic Hydrocarbons (PAHs), to activated carbon, and thus the hydrocarbons can be removed from the separated discharge gas. The second dewatered gas is introduced into the second outlet adsorption device 170 via the second dewatering line L17. The second outlet adsorption device 170 sends the second dewatered gas from which the hydrocarbons are removed to the second removal line L18. In the second outlet adsorption device 170, for example, a tank extending in the vertical direction is filled with activated carbon, and the second dewatered gas can flow in the tank.

The second removal line L18 can supply the second dewatered gas discharged from the second outlet adsorption device 170 to the third compressor 180. The second removal line L18 is a pipeline that connects together the second outlet adsorption device 170 and the third compressor 180.

### Third Compressor

The third compressor 180 compresses the supplied second dewatered gas. The second dewatered gas is introduced into the third compressor 180 via the second removal line L18. That is, the third compressor 180 further compresses the separated discharge gas after being compressed by the second compressor 150. In addition, the third compressor 180 is on the same shaft with the first compressor 130 and the second compressor 150 (has a structure having an integrated rotor). The third compressor 180 is connected to the fourth compressor 190 via a third compression line L19. The third compressor 180 discharges the second dewatered gas which is compressed.

The third compression line L19 can supply the second dewatered gas discharged from the third compressor 180 to the fourth compressor 190. The third compression line L19 is a pipeline that connects together the third compressor 180 and the fourth compressor 190.

### Fourth Compressor

The fourth compressor 190 further compresses the supplied second dewatered gas. The second dewatered gas is introduced into the fourth compressor 190 via the third compression line L19. That is, the fourth compressor 190 further compresses the separated discharge gas after being compressed by the third compressor 180. In addition, the fourth compressor 190 is on the same shaft with the first compressor 130, the second compressor 150, and the third compressor 180 (a structure having an integrated rotor). In the second embodiment, the four compressors including the first compressor 130, the second compressor 150, the third compressor 180, and the fourth compressor 190 perform compression until the regeneration tower discharge gas is in a state according to the purpose of use, such as a supercritical state or a liquid state. The fourth compressor 190 discharges the second dewatered gas which is compressed to the fourth compression line L20.

The fourth compression line L20 can discharge the second dewatered gas discharged from the fourth compressor 190 to the outside (outside the system). As in the first removal line L13 of the first embodiment, for example, the fourth compression line L20 transfers the second dewatered gas, which is compressed after removing the hydrocarbons, to an external transfer destination according to the purpose of use. The separated discharge gas from which the hydrocarbons discharged from the fourth compression line L20 are removed is transferred to, for example, a state according to the purpose of use and is stored by a tank, a lorry, a pipeline, the inside of an oil field, an aquifer, or the like.

The first dewatering drain line L21 supplies the dewatered drain water discharged from the first dewatering device 140 to the dewatered drain water adsorption device 220. The first dewatering drain line L21 is a pipeline that connects together the first dewatering device 140 and the dewatered drain water adsorption device 220.

The second dewatering drain line L22 supplies the dewatered drain water discharged from the second dewatering device 160 to the dewatered drain water adsorption device 220. The second dewatering drain line L22 supplies the dewatered drain water to the dewatered drain water adsorption device 220 via the first dewatering drain line L21. The second dewatering drain line L22 is a pipeline that connects together the second dewatering device 160 and the first dewatering drain line L21.

### Dewatered Drain Water Adsorption Device

The dewatered drain water adsorption device 220 is a drain water adsorption device that brings the dewatered drain water supplied from the first dewatering device 140 and the second dewatering device 160 to the regeneration tower 5 into contact with activated carbon to remove hydrocarbons remaining in the dewatered drain water. That is, the dewatered drain water adsorption device 220 brings the dewatered drain water, which is a liquid, into contact with the activated carbon. The dewatered drain water adsorption device 220 can remove hydrocarbons having a high boiling point, which contain Polycyclic Aromatic Hydrocarbons (PAHs), from dewatered drain water by adsorbing the hydrocarbons to activated carbon. The dewatered drain water is introduced into the dewatered drain water adsorption device 220 via the first dewatering drain line L21. The dewatered drain water adsorption device 220 sends the dewatered drain water from which the hydrocarbons are removed to the dewatered drain water line L23. In the dewatered drain water adsorption device 220, for example, a tank extending in the vertical direction is filled with activated carbon, and the dewatered drain water can flow in the tank.

The dewatered drain water line L23 supplies the dewatered drain water discharged from the dewatered drain water adsorption device 220 to the regeneration tower 5. The dewatered drain water line L23 joins the dewatered drain water with the drain water via a drain return line L110 and supplies the joined water to the regeneration tower 5. As a result, the dewatered drain water and the drain water join the absorbent liquid in the regeneration tower 5. The dewatered drain water line L23 is a pipeline that connects together the dewatered drain water adsorption device 220 and the drain return line L110. The dewatered drain water line L23 is connected to the drain return line L110 between the drain return pump 111 and the gas-liquid separator 8.

### Separated Drain Water Adsorption Device

The separated drain water adsorption device 230 is a drain water adsorption device that brings the separated drain water supplied from the gas-liquid separator 8 to the regeneration tower 5 into contact with activated carbon to remove hydrocarbons remaining in the separated drain water. That is, the carbon dioxide recovery system 1A of the second embodiment includes a plurality of drain water adsorption devices. The separated drain water adsorption device 230 of the second embodiment brings a liquid in which separated drain water and dewatered drain water from which hydrocarbons are removed are joined into contact with activated carbon. The separated drain water adsorption device 230 adsorbs hydrocarbons having a high boiling point, which contain Polycyclic Aromatic Hydrocarbons (PAHs), to activated carbon, and thus the hydrocarbons can be removed from the separated drain water. The separated drain water adsorption device 230 is disposed in the middle of the drain return line L110. The separated drain water adsorption device 230 is disposed between the drain return pump 111 and the regeneration tower 5. The separated drain water which is pressurized and the dewatered drain water are introduced into the separated drain water adsorption device 230 via the drain return line L110. The separated drain water adsorption device 230 sends the liquid from which the hydrocarbons are removed to the regeneration tower 5. In the separated drain water adsorption device 230, for example, a tank extending in the vertical direction is filled with activated carbon, and a mixed liquid of the separated drain water and the dewatered drain water can flow in the tank.

In addition, the first drain water return line L25 supplies the mixed liquid of the separated drain water, which is the drain water discharged from the separated drain water adsorption device 230, and the dewatered drain water to the absorption tower 4. The first drain water return line L25 supplies a part of the drain water, which is discharged from the dewatered drain water adsorption device 220 and supplied to the regeneration tower 5, to the water washing section 42. As a result, the separated drain water adsorption device 230, which is the drain water adsorption device, supplies the separated drain water brought into contact with the activated carbon to the water washing section 42. The first drain water return line L25 is a pipeline that connects together the drain return line L110 and the water washing section 42. The first drain water return line L25 is connected to the drain return line L110 between the separated drain water adsorption device 230 and the regeneration tower 5.

The second drain water return line L26 supplies the dewatered drain water, which is the drain water discharged from the dewatered drain water adsorption device 220, to the absorption tower 4. The second drain water return line L26 supplies a part of the dewatered drain water to the water washing section 42 before the dewatered drain water is discharged from the dewatered drain water adsorption device 220 and joins the drain return line L110. Accordingly, the dewatered drain water adsorption device 220, which is the drain water adsorption device, supplies the dewatered drain water brought into contact with the activated carbon to the water washing section 42. The second drain water return line L26 is a pipeline that connects together the dewatered drain water line L23 and the first drain water return line L25. The second drain water return line L26 supplies the dewatered drain water to the first drain water return line L25 to supply the dewatered drain water to the water washing section 42 together with the mixed liquid.

### Operation and Effect

In the carbon dioxide recovery system 1A of the second embodiment, by the second outlet adsorption device 170, the second dewatered gas dewatered by the second dewatering device 160 comes in contact with the activated carbon to remove the remaining hydrocarbons. That is, the hydrocarbons are removed from the regeneration tower discharge gas discharged from the regeneration tower 5. Therefore, the hydrocarbons are removed from the regeneration tower discharge gas generated from the target gas of treatment in a state in which the hydrocarbons have already been removed by the inlet adsorption device 3. Further, since the second dewatered gas is dewatered by the second dewatering device 160, the moisture concentration is lowered, and the adsorption performance of the activated carbon can be improved. As a result, it is possible to improve the removal efficiency of the hydrocarbons from the second dewatered gas. Therefore, the purity of the carbon dioxide gas finally discharged from the carbon dioxide recovery system 1A can be increased, and the quality can be further improved.

In addition, since the second dewatered gas is compressed by the first compressor 130 and the second compressor 150, the gas volume (flow rate) of the second dewatered gas is further lowered. Therefore, the volume of the activated carbon to be brought into contact with the second dewatered gas can be further reduced. Therefore, it is possible to reduce the size of the second outlet adsorption device 170.

In addition, in the second embodiment, a second outlet adsorption device 170 is disposed in addition to the first outlet adsorption device 9. That is, the hydrocarbons are removed from the regeneration tower discharge gas discharged from the regeneration tower 5 by using activated carbon by a plurality of outlet adsorption devices. Therefore, the purity of the carbon dioxide gas finally discharged from the carbon dioxide recovery system 1A can be further increased, and the quality can be further improved.

In addition, the first outlet adsorption device 9 and the second outlet adsorption device 170 discharge gas from which hydrocarbons are removed to the downstream side. As a result, only the gas in which the hydrocarbons are reduced can be supplied to the downstream device with respect to the second outlet adsorption device 170, such as the plurality of compressors from the first compressor 130 to the fourth compressor 190 or the plurality of dewatering devices such as the first dewatering device 140 and the second dewatering device 160. Therefore, precipitation or fouling of hydrocarbons in a downstream device can be suppressed. As a result, the operation reliability of the compressor or the dewatering device is improved, and the operation time as the carbon dioxide recovery system 1A can be extended.

Further, in the present embodiment, glycol dewatering is performed by the first dewatering device 140 and the second dewatering device 160. In a case of comparison in terms of dewatering performance, in glycol dewatering, since dewatering can be performed to several tens of ppm or less with triethylene glycol (TEG), a smaller amount of carbon dioxide gas with a smaller amount of moisture is obtained as compared to simple gas-liquid separation such as the gas-liquid separator 8. Therefore, hydrocarbons can be removed with a smaller amount of adsorbent.

In addition, the separated drain water discharged from the gas-liquid separator 8 by the separated drain water adsorption device 230 is joined to the dewatered drain water and then comes into contact with activated carbon to remove hydrocarbons. Then, the separated drain water from which the hydrocarbons are removed is supplied to the regeneration tower 5 and is joined to the absorbent liquid. Therefore, the absorbent liquid can be diluted with a liquid in which the hydrocarbons are reduced. Therefore, the concentration of hydrocarbons in the absorbent liquid can be reduced. As a result, it is possible to suppress an increase in the concentration of hydrocarbons in the absorbent liquid in a process of circulating between the regeneration tower 5 and the absorption tower 4.

In addition, hydrocarbons are removed from separated drain water and dewatered drain water instead of removing hydrocarbons from the absorbent liquid itself. The concentration of the amines contained in the separated drain water and the dewatered drain water is very small as compared with the absorbent liquid. Therefore, by bringing the separated drain water and the dewatered drain water into contact with the activated carbon, it is possible to suppress the degree of adsorption inhibition of the activated carbon to the hydrocarbons and to improve the adsorption performance of the hydrocarbons, as compared with a case where the absorbent liquid containing a high concentration of amine is brought into contact with the activated carbon. Therefore, with the configuration in which the hydrocarbons are removed from the drain water, the hydrocarbons can be removed with a small amount of the adsorbent.

In addition, the dewatered drain water being supplied from the first dewatering device 140 to the regeneration tower 5 is brought into contact with activated carbon by the dewatered drain water adsorption device 220, and thus hydrocarbons are removed. Therefore, the dewatered drain water from which the hydrocarbons are removed is supplied to the regeneration tower 5 after being joined to the separated drain water, and is joined to the absorbent liquid. That is, it is possible to suppress an increase in the concentration of hydrocarbons in the separated drain water to which the dewatered drain water is joined. Therefore, the absorbent liquid can be diluted with a liquid in which the hydrocarbons are further reduced. Therefore, the concentration of hydrocarbons in the absorbent liquid can be reduced. As a result, it is possible to suppress an increase in the concentration of hydrocarbons in the absorbent liquid in a process of circulating between the regeneration tower 5 and the absorption tower 4.

In addition, the liquid from which the hydrocarbons are removed by the separated drain water adsorption device 230 or the dewatered drain water adsorption device 220 is discharged to the downstream regeneration tower 5. As a result, only the liquid in which the hydrocarbons are reduced can be supplied to the downstream device (for example, the drain return pump 111 or the regeneration tower 5) with respect to the separated drain water adsorption device 230 and the dewatered drain water adsorption device 220. Therefore, precipitation or fouling of hydrocarbons in a downstream device can be suppressed. As a result, the operation reliability of the drain return pump 111 and the regeneration tower 5 is improved, and the operation time as the carbon dioxide recovery system 1A can be extended.

In addition, a mixed liquid of separated drain water and dewatered drain water discharged from the separated drain water adsorption device 230 is supplied to the water washing section 42 through the first drain water return line L25. Further, the dewatered drain water discharged from the dewatered drain water adsorption device 220 is supplied to the water washing section 42 by the second drain water return line L26. The hydrocarbons contained in the drain water discharged from the first dewatering device 140, the second dewatering device 160, or the gas-liquid separator 8 have a high proportion of components that are easily volatilized in the regeneration tower 5. In a case where such drain water is returned to the water washing section 42 without passing through the activated carbon, there is a possibility that a component that is easily volatilized passes through the water washing section 42 and is discharged to the atmosphere from the outlet of the absorption tower 4. However, by returning the separated drain water and the dewatered drain water to the water washing section 42, which have passed through the separated drain water adsorption device 230 or the dewatered drain water adsorption device 220, it is possible to suppress the components that are easily volatilized (or have a high vapor pressure) from being discharged from the outlet of the absorption tower 4 to the atmosphere.

### Third Embodiment

Next, a carbon dioxide recovery system 1B according to a third embodiment of the present disclosure will be described. In addition, in the third embodiment to be described below, in the drawings, the same reference signs are given to the configurations common to the first embodiment and second embodiment, and a description thereof will be omitted. In the third embodiment, the difference from the second embodiment is that a coalescer 300 capable of separating hydrocarbons by oil-water separation is provided.

In the carbon dioxide recovery system 1B of the third embodiment, hydrocarbons can be removed from a rich liquid flowing through a rich line L6. The carbon dioxide recovery system 1B further includes the coalescer 300.

### Coalescer

The coalescer 300 can separate hydrocarbons from a rich liquid or a lean liquid by oil-water separation. The coalescer 300 of the present embodiment is supplied with a rich liquid that is discharged from the absorption tower 4 and is supplied to the absorbent liquid heat exchanger 6. The coalescer 300 is disposed in the middle of the rich line L6. The coalescer 300 is disposed on the rich line L6 between the rich pump 61 and the absorbent liquid heat exchanger 6. The coalescer 300 is, for example, a cylindrical filter, and the rich liquid passes through the inside thereof, so that hydrocarbons, which are formed into fine oil particles in the emulsified liquid (emulsion) on the fiber surface of the filter, are coarsened and adsorbed. Then, a rich liquid from which hydrocarbons are separated is discharged from the coalescer 300. The coalescer 300 separates hydrocarbons from the entire amount of the rich liquid flowing in the rich line L6. The coalescer 300 is not limited to a structure of being disposed in the rich line L6. The coalescer 300 may have a structure of being disposed in the lean line L8 to separate hydrocarbons from the lean liquid.

### Operation and Effect

In the carbon dioxide recovery system 1B of the third embodiment, the hydrocarbons are separated from the rich liquid flowing in the rich line L6 by the coalescer 300. In particular, in the present embodiment, hydrocarbons are separated from the total amount of the rich liquid flowing in the rich line L6. That is, hydrocarbons can be removed from the absorbent liquid circulating between the regeneration tower 5 and the absorption tower 4. In particular, an absorbent liquid such as an amine aqueous solution, which is a high-concentration solution, has incorporated hydrocarbons to be an emulsified liquid. On the other hand, by disposing the coalescer 300 instead of the activated carbon or the filter in the rich line L6, fine hydrocarbons contained in the emulsified liquid can be efficiently recovered. Therefore, it is possible to suppress the accumulation of hydrocarbons in the circulating absorbent liquid.

In addition, since the coalescer 300 is disposed in the rich line L6 instead of the lean line L8, hydrocarbons can be removed from the absorbent liquid having a high concentration of hydrocarbons together with amines. Therefore, the hydrocarbons can be efficiently recovered as compared with a case where the coalescer 300 is disposed in the lean line L8.

### Other Embodiments

The embodiments of the present disclosure have been described above in detail with reference to the drawings. However, specific configurations are not limited to the embodiments, and include a design modification or the like within a scope which does not depart from the gist of the present disclosure.

The configurations of the first to third embodiments may be combined with each other in various ways. Therefore, for example, the configuration of the third embodiment may be further combined with the configuration of the first embodiment.

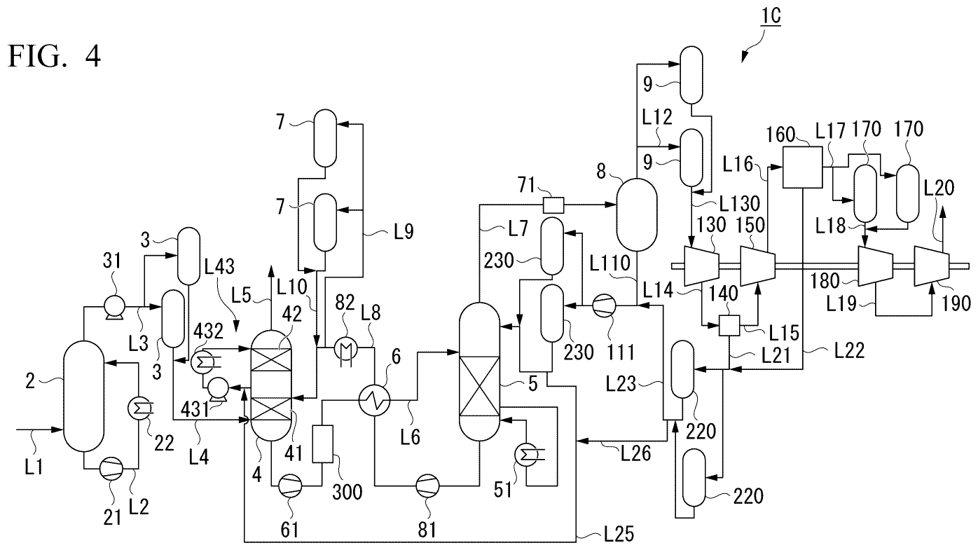

In addition, the inlet adsorption device 3, the lean liquid adsorption device 7, the first outlet adsorption device 9, the second outlet adsorption device 170, the dewatered drain water adsorption device 220, and the separated drain water adsorption device 230 are not limited to the configuration in which only one is disposed for gas or liquid as in the above-described embodiment. The inlet adsorption device 3, the lean liquid adsorption device 7, the first outlet adsorption device 9, the second outlet adsorption device 170, the dewatered drain water adsorption device 220, and the separated drain water adsorption device 230 may be disposed in parallel with each other with respect to the gas or the liquid. For example, as shown in FIG. 4, in the carbon dioxide recovery system 1C, the inlet adsorption device 3, the lean liquid adsorption device 7, the first outlet adsorption device 9, the second outlet adsorption device 170, the dewatered drain water adsorption device 220, and the separated drain water adsorption device 230 are disposed in parallel, and thus, the devices can be switched and used in an emergency state such as a case where each device is blocked (pressure loss increases) or a case where the performance is lowered. As a result, the carbon dioxide recovery system 1C can be stably operated and continued.

In addition, as in the second embodiment, the carbon dioxide recovery system 1, 1A, 1B, 1C is not limited to the configuration of having all of the inlet adsorption device 3, the lean liquid adsorption device 7, the first outlet adsorption device 9, the second outlet adsorption device 170, the dewatered drain water adsorption device 220, and the separated drain water adsorption device 230. In the carbon dioxide recovery system 1, 1A, 1B, as long as the inlet adsorption device 3 is provided, the lean liquid adsorption device 7, the first outlet adsorption device 9, the second outlet adsorption device 170, the dewatered drain water adsorption device 220, and the separated drain water adsorption device 230 may not be disposed at all. In addition, any one of or only a part of the lean liquid adsorption device 7, the first outlet adsorption device 9, the second outlet adsorption device 170, the dewatered drain water adsorption device 220, or the separated drain water adsorption device 230 may be disposed. In this case, a combination of the lean liquid adsorption device 7, the first outlet adsorption device 9, the second outlet adsorption device 170, the dewatered drain water adsorption device 220, and the separated drain water adsorption device 230 to be disposed can be appropriately set.

### Appendix

The acidic gas recovery system described in each embodiment is understood as follows, for example.

(1) An acidic gas recovery system according to a first aspect includes a cooling tower 2 into which a target gas of treatment containing an acidic gas as a recovery target gas is introduced to cool the target gas of treatment; an inlet adsorption device 3 that is configured to bring the target gas of treatment cooled in the cooling tower 2 into contact with activated carbon to remove hydrocarbons remaining in the target gas of treatment; an absorption tower 4 into which the target gas of treatment from which the hydrocarbons are removed by the inlet adsorption device 3 is introduced, and that is configured to bring the target gas of treatment into contact with an absorbent liquid to discharge the absorbent liquid which has absorbed the acidic gas and an absorption tower discharge gas containing the target gas of treatment from which the acidic gas is removed; and a regeneration tower 5 that is configured to release the acidic gas from the absorbent liquid discharged from the absorption tower 4 to discharge the absorbent liquid from which the acidic gas is released and to discharge a regeneration tower discharge gas containing the acidic gas.

With such a configuration, the target gas of treatment cooled in the cooling tower 2 is supplied to the inlet adsorption device 3, comes into contact with activated carbon to remove the hydrocarbons. Therefore, the inflow of the hydrocarbons into the absorption tower 4 can be suppressed. Further, in the inlet adsorption device 3, hydrocarbons are removed from the target gas of treatment after being cooled in the cooling tower 2. In the target gas of treatment after being cooled in the cooling tower 2, the gas temperature is simply lowered, and the moisture concentration is also reduced as the gas temperature is lowered. By reducing the moisture concentration, the adsorption performance of the activated carbon for the hydrocarbons is improved in the target gas of treatment after being cooled, as compared with the target gas of treatment before being cooled. As a result, the activated carbon is efficiently used for adsorption of hydrocarbons, and the mixing of hydrocarbons into the absorbent liquid can be efficiently suppressed.

(2) An acidic gas recovery system according to a second aspect is the acidic gas recovery system of (1) further includes an outlet adsorption device that is configured to bring the regeneration tower discharge gas discharged from the regeneration tower 5 into contact with activated carbon to remove the hydrocarbons remaining in the regeneration tower discharge gas.

With such a configuration, the hydrocarbons are removed from the regeneration tower discharge gas discharged from the regeneration tower 5. Therefore, the inlet adsorption device 3 further removes the hydrocarbons from the regeneration tower discharge gas generated from the target gas of treatment in a state in which the hydrocarbons are already removed and reduced. Therefore, the purity of the regeneration tower discharge gas from which the carbon dioxide is removed can be increased. As a result, it is possible to improve the quality of the gas from which carbon dioxide finally discharged from the carbon dioxide recovery system 1, 1A, 1B is removed.

(3) An acidic gas recovery system according to a third aspect is the acidic gas recovery system of (2) further including a dewatering device that is configured to absorb moisture contained in the regeneration tower discharge gas discharged from the regeneration tower 5, in which the outlet adsorption device brings the regeneration tower discharge gas discharged from the dewatering device into contact with activated carbon.

With such a configuration, since the regeneration tower discharge gas is dewatered by the dewatering device, the moisture concentration is lowered, and the adsorption performance of the activated carbon can be improved. As a result, it is possible to improve the removal efficiency of hydrocarbons from the regeneration tower discharge gas discharged from the dewatering device. Therefore, the purity of the gas, which is finally discharged from the carbon dioxide recovery system 1, 1A, 1B and from which the carbon dioxide is removed, is increased, and the quality can be further improved.

(4) An acidic gas recovery system according to a fourth aspect is the acidic gas recovery system of any one of (1) to (3), further including a gas-liquid separator 8 that is configured to separate moisture contained in the regeneration tower discharge gas discharged from the regeneration tower 5 to discharge separated discharge gas from which the moisture is separated and supply the separated moisture to the regeneration tower 5 as drain water; and a drain water adsorption device 230 that is configured to bring the drain water supplied from the gas-liquid separator 8 to the regeneration tower 5 into contact with activated carbon to remove the hydrocarbons remaining in the drain water.

With such a configuration, the drain water from which the hydrocarbons are removed is supplied to the regeneration tower 5 to join to the absorbent liquid. Therefore, the absorbent liquid can be diluted with a liquid in which the hydrocarbons are reduced. Therefore, the concentration of hydrocarbons in the absorbent liquid can be reduced. As a result, it is possible to suppress an increase in the concentration of hydrocarbons in the absorbent liquid in a process of circulating between the regeneration tower 5 and the absorption tower 4.

(5) An acidic gas recovery system according to a fifth aspect is the acidic gas recovery system of any one of (1) to (4) further including a dewatering device that is configured to absorb moisture contained in the regeneration tower discharge gas discharged from the regeneration tower 5, and supplies the absorbed moisture to the regeneration tower 5 as dewatered drain water; and a dewatered drain water adsorption device 220 that is configured to bring the dewatered drain water supplied from the dewatering device to the regeneration tower 5 into contact with activated carbon to remove the hydrocarbons remaining in the dewatered drain water.

With such a configuration, the dewatered drain water from which the hydrocarbons are removed is supplied to the regeneration tower 5 to join to the absorbent liquid. Therefore, the absorbent liquid can be diluted with the dewatered drain water in which the hydrocarbons are reduced. Therefore, the concentration of hydrocarbons in the absorbent liquid can be reduced. As a result, it is possible to suppress an increase in the concentration of hydrocarbons in the absorbent liquid in a process of circulating between the regeneration tower 5 and the absorption tower 4.

(6) An acidic gas recovery system according to a sixth aspect is the acidic gas recovery system of any one of (1) to (5), further including a rich line L6 that is configured to supply a rich liquid which is the absorbent liquid which has absorbed the acidic gas from the absorption tower 4 to the regeneration tower 5, a lean line L8 that is configured to supply a lean liquid which is the absorbent liquid from which the acidic gas is released from the regeneration tower 5 to the absorption tower 4, and a coalescer 300 that is configured to separate the hydrocarbons from the rich liquid or the lean liquid by oil-water separation.

According to such a configuration, the hydrocarbons can be removed from the absorbent liquid circulating between the regeneration tower 5 and the absorption tower 4, and thus the accumulation of hydrocarbons in the circulating absorbent liquid can be suppressed.

(7) An acidic gas recovery system according to a seventh aspect is the acidic gas recovery system of (6), further including an absorbent liquid heat exchanger 6 that is configured to perform heat exchange between the rich liquid flowing through the rich line L6 and the lean liquid flowing through the lean line L8 to heat the rich liquid and cool the lean liquid, in which the coalescer 300 separates the hydrocarbons from the rich liquid obtained before being discharged from the absorption tower 4 and being supplied to the absorbent liquid heat exchanger 6, by the oil-water separation.

According to such a configuration, since the coalescer 300 is disposed at the rich line L6 instead of the lean line L8, the hydrocarbons can be removed from the absorbent liquid having a high concentration of hydrocarbons, together with amines. Therefore, the hydrocarbons can be efficiently recovered as compared with a case where the coalescer 300 is disposed in the lean line L8.

(8) An acidic gas recovery system according to an eighth aspect is the acidic gas recovery system of any one of (1) to (7), in which a plurality of the inlet adsorption devices 3 are connected to the cooling tower 2 and the absorption tower 4 in parallel with each other.

With such a configuration, the devices can be switched and used in an emergency state such as a case where each device is blocked (pressure loss increases) or a case where the performance is lowered. As a result, the carbon dioxide recovery system can be continuously operated stably.

(9) An acidic gas recovery system according to a ninth aspect includes an absorption tower 4 into which a target gas of treatment containing an acidic gas as a recovery target gas is introduced, and that is configured to bring the target gas of treatment into contact with an absorbent liquid to discharge the absorbent liquid which has absorbed the acidic gas and an absorption tower discharge gas containing the target gas of treatment from which the acidic gas is removed; a regeneration tower 5 that is configured to release the acidic gas from the absorbent liquid discharged from the absorption tower 4 to discharge the absorbent liquid from which the acidic gas is released and a regeneration tower discharge gas containing the acidic gas; a gas-liquid separator 8 that is configured to separate moisture contained in the regeneration tower discharge gas discharged from the regeneration tower 5 to discharge a separated discharge gas from which the moisture is separated and supply the separated moisture to the regeneration tower 5 as drain water; a dewatering device 140, 160 that is configured to absorb the moisture contained in the regeneration tower discharge gas discharged from the regeneration tower 5; and a drain water adsorption device 220, 230 that is configured to bring the drain water supplied from at least one of the gas-liquid separator 8 and the dewatering device 140, 160 to the regeneration tower 5 into contact with activated carbon to remove hydrocarbons remaining in the drain water.

With such a configuration, hydrocarbons are removed from the drain water instead of removing hydrocarbons from the absorbent liquid itself. The concentration of amines contained in the drain water is extremely small as compared with the absorbent liquid. Therefore, in a case where the drain water is brought into contact with the activated carbon, the degree of inhibition of adsorption to the hydrocarbons by the activated carbon can be suppressed, and the adsorption performance of the hydrocarbons can be improved, as compared with a case where the absorbent liquid containing a high concentration of amine is brought into contact with the activated carbon. Therefore, with the configuration in which the hydrocarbons are removed from the drain water, the hydrocarbons can be removed with a small amount of the adsorbent. (10) An acidic gas recovery system according to a tenth aspect is the acidic gas recovery system of (9), in which the drain water adsorption device 230 brings the drain water discharged from the gas-liquid separator 8 into contact with the activated carbon.

With such a configuration, the absorbent liquid can be diluted with a liquid in which the hydrocarbons are reduced. Therefore, the concentration of hydrocarbons in the absorbent liquid can be reduced. As a result, it is possible to suppress an increase in the concentration of hydrocarbons in the absorbent liquid in a process of circulating between the regeneration tower 5 and the absorption tower 4.

(11) An acidic gas recovery system according to an eleventh aspect is the acidic gas recovery system of (9) or (10), in which the drain water adsorption device 220 brings the drain water discharged from the dewatering device 140, 160 into contact with the activated carbon.

With such a configuration, it is possible to suppress an increase in the concentration of hydrocarbons in the drain water. Therefore, the absorbent liquid can be diluted with a liquid in which the hydrocarbons are further reduced. Therefore, the concentration of hydrocarbons in the absorbent liquid can be reduced. As a result, it is possible to suppress an increase in the concentration of hydrocarbons in the absorbent liquid in a process of circulating between the regeneration tower 5 and the absorption tower 4.

(12) An acidic gas recovery system according to a twelfth aspect is the acidic gas recovery system of any one of (9) to (11), in which the drain water adsorption device 220, 230 supplies the drain water brought into contact with the activated carbon to the regeneration tower 5.

With such a configuration, only a liquid in which the hydrocarbons are reduced can be supplied to the equipment downstream of the drain water adsorption device 220, 230. Therefore, precipitation or fouling of hydrocarbons in a downstream device can be suppressed. As a result, the operation reliability of the downstream device is improved, and the operation time as the carbon dioxide recovery system can be extended.

(13) An acidic gas recovery system according to a thirteenth aspect is the acidic gas recovery system of any one of (9) to (12), in which the absorption tower 4 includes a recovery section 41 that is configured to bring the target gas of treatment into contact with the absorbent liquid to cause the absorbent liquid to recover the acidic, and a water washing section 42 that is configured to bring a decarbonized gas obtained after being brought into contact with the absorbent liquid in the recovery section 41 into contact with washing water to recover an absorbent liquid component accompanied in the decarbonized gas, and the drain water adsorption device 220, 230 that is configured to supply the drain water brought into contact with the activated carbon to the water washing section 42.

With such a configuration, the hydrocarbons contained in the drain water discharged from the dewatering device 140, 160, or the gas-liquid separator 8 have a high proportion of components that are easily volatilized in the regeneration tower 5. In a case where such drain water is returned to the water washing section 42 without passing through the activated carbon, there is a possibility that a component that is easily volatilized passes through the water washing section 42 and is discharged to the atmosphere from the outlet of the absorption tower 4. However, by returning the drain water that has passed through the drain water adsorption device 220, 230 to the water washing section 42, it is possible to suppress the components that are easily volatilized (or have a high vapor pressure) from being discharged from the outlet of the absorption tower 4 to the atmosphere.

(14) An acidic gas recovery system according to a fourteenth aspect is the acidic gas recovery system of any one of (9) to (13) further includes an outlet adsorption device 9, 170 that is configured to bring the regeneration tower discharge gas discharged from the regeneration tower 5 into contact with activated carbon to remove the hydrocarbons remaining in the regeneration tower discharge gas.

With such a configuration, since the regeneration tower discharge gas is dewatered by the dewatering device 140, 160, the moisture concentration is lowered, and the adsorption performance of the activated carbon can be improved. As a result, it is possible to improve the removal efficiency of the hydrocarbons from the regeneration tower discharge gas. Therefore, the purity of the carbon dioxide gas finally discharged from the carbon dioxide recovery system can be increased, and the quality can be further improved.

(15) An acidic gas recovery system according to a fifteenth aspect is the acidic gas recovery system of any one of (9) to (14), further including a rich line L6 that is configured to supply a rich liquid which is the absorbent liquid which has absorbed the acidic gas from the absorption tower 4 to the regeneration tower 5, a lean line L8 that is configured to supply a lean liquid which is the absorbent liquid from which the acidic gas is released from the regeneration tower 5 to the absorption tower 4, and a coalescer 300 that is configured to separate the hydrocarbons from the rich liquid or the lean liquid by oil-water separation.

With such a configuration, the hydrocarbons can be removed from the absorbent liquid circulating between the regeneration tower 5 and the absorption tower 4, and thus the accumulation of hydrocarbons in the circulating absorbent liquid can be suppressed.

(16) An acidic gas recovery system according to a sixteenth aspect is the acidic gas recovery system of (15), further including an absorbent liquid heat exchanger 6 that is configured to perform heat exchange between the rich liquid flowing through the rich line L6 and the lean liquid flowing through the lean line L8 to heat the rich liquid and cool the lean liquid, in which the coalescer 300 separates the hydrocarbons from the rich liquid obtained before being discharged from the absorption tower 4 and being supplied to the absorbent liquid heat exchanger 6, by the oil-water separation.

According to such a configuration, since the coalescer 300 is disposed at the rich line L6 instead of the lean line L8, the hydrocarbons can be removed from the absorbent liquid having a high concentration of hydrocarbons, together with amines. Therefore, the hydrocarbons can be efficiently recovered as compared with a case where the coalescer 300 is disposed in the lean line L8.

(17) An acidic gas recovery system according to a seventeenth aspect includes an absorption tower 4 into which a target gas of treatment containing an acidic gas as a recovery target gas is introduced, and that is configured to bring the target gas of treatment into contact with an absorbent liquid to discharge the absorbent liquid which has absorbed the acidic gas and an absorption tower discharge gas containing the target gas of treatment from which the acidic gas is removed; a regeneration tower 5 that is configured to release the acidic gas from the absorbent liquid discharged from the absorption tower 4 to discharge the absorbent liquid from which the acidic gas is released and a regeneration tower discharge gas containing the acidic gas; a dewatering device 140, 160 that is configured to absorb moisture contained in the regeneration tower discharge gas discharged from the regeneration tower 5; and an outlet adsorption device 9, 170 that is configured to bring the regeneration tower discharge gas from which the moisture is removed in the dewatering device 140, 160 into contact with activated carbon to remove hydrocarbons remaining in the regeneration tower discharge gas.

With such a configuration, since the regeneration tower discharge gas is dewatered by the dewatering device 140, 160, the moisture concentration is lowered, and the adsorption performance of the activated carbon can be improved. As a result, it is possible to improve the removal efficiency of the hydrocarbons from the regeneration tower discharge gas. Therefore, the purity of the carbon dioxide gas finally discharged from the carbon dioxide recovery system can be increased, and the quality can be further improved.

### EXPLANATION OF REFERENCES

1, 1A, 1B, 1C: carbon dioxide recovery system (acidic gas recovery system)
L1: supply line
2: cooling tower
L2: supply cooling circulation line
21: supply circulation pump
22: supply circulation cooler
L3: cooler discharge line
31: supply blower
3: inlet adsorption device
L4: inlet adsorption line
4: absorption tower
41: recovery section
42: water washing section
43: absorption tower circulation section
431: absorption tower circulation pump
432: absorption tower circulation heat exchanger
L5: absorption tower discharge line
L6: rich line
61: rich pump
5: regeneration tower
51: reboiler
L7: regeneration tower discharge gas line
71: regeneration tower discharge gas condenser
L8: lean line
81: lean pump
82: lean cooler
6: absorbent liquid heat exchanger
L9: lean liquid adsorption supply line
7: lean liquid adsorption device
L10: lean liquid adsorption discharge line
8: gas-liquid separator
L11, L110: drain return line
111: drain return pump
L12: separated discharge gas line
9: first outlet adsorption device
L13, L130: first removal line
130: first compressor
L14: first compression line
140: first dewatering device
L15: first dewatering line
150: second compressor
L16: second compression line
160: second dewatering device
L17: second dewatering line
170: second outlet adsorption device
L18: second removal line
180: third compressor
L19: third compression line
190: fourth compressor
L20: fourth compression line
L21: first dewatering drain line
L22: second dewatering drain line
220: dewatered drain water adsorption device
L23: dewatered drain water line
230: separated drain water adsorption device
300: coalescer
L25: first drain water return line
L26: second drain water return line

1. An acidic gas recovery system comprising:
a cooling tower into which a target gas of treatment containing an acidic gas as a recovery target gas is introduced to cool the target gas of treatment;
an inlet adsorption device that is configured to bring the target gas of treatment cooled in the cooling tower into contact with activated carbon to remove hydrocarbons remaining in the target gas of treatment;
an absorption tower into which the target gas of treatment from which the hydrocarbons are removed by the inlet adsorption device is introduced, and that is configured to bring the target gas of treatment into contact with an absorbent liquid to discharge the absorbent liquid which has absorbed the acidic gas and to discharge an absorption tower discharge gas containing the target gas of treatment from which the acidic gas is removed; and
a regeneration tower that is configured to release the acidic gas from the absorbent liquid discharged from the absorption tower to discharge the absorbent liquid from which the acidic gas is released and to discharge a regeneration tower discharge gas containing the acidic gas.

2. The acidic gas recovery system according to claim 1, further comprising:
an outlet adsorption device that is configured to bring the regeneration tower discharge gas discharged from the regeneration tower into contact with activated carbon to remove the hydrocarbons remaining in the regeneration tower discharge gas.

3. The acidic gas recovery system according to claim 2, further comprising:
a dewatering device that is configured to absorb moisture contained in the regeneration tower discharge gas discharged from the regeneration tower,
wherein the outlet adsorption device brings the regeneration tower discharge gas discharged from the dewatering device into contact with activated carbon.

4. The acidic gas recovery system according to claim 1, further comprising:
a gas-liquid separator that is configured to separate moisture contained in the regeneration tower discharge gas discharged from the regeneration tower to discharge separated discharge gas from which the moisture is separated and supply the separated moisture to the regeneration tower as drain water; and
a drain water adsorption device that is configured to bring the drain water supplied from the gas-liquid separator to the regeneration tower into contact with activated carbon to remove the hydrocarbons remaining in the drain water.

5. The acidic gas recovery system according to claim 1, further comprising:
a dewatering device that is configured to absorb moisture contained in the regeneration tower discharge gas discharged from the regeneration tower, and supply the absorbed moisture to the regeneration tower as dewatered drain water; and
a dewatered drain water adsorption device that is configured to bring the dewatered drain water supplied from the dewatering device to the regeneration tower into contact with activated carbon to remove the hydrocarbons remaining in the dewatered drain water.

6. The acidic gas recovery system according to claim 1, further comprising:
a rich line that is configured to supply a rich liquid which is the absorbent liquid which has absorbed the acidic gas from the absorption tower to the regeneration tower;
a lean line that is configured to supply a lean liquid which is the absorbent liquid from which the acidic gas is released from the regeneration tower to the absorption tower; and
a coalescer that is configured to separate the hydrocarbons from the rich liquid or the lean liquid by oil-water separation.

7. The acidic gas recovery system according to claim 6, further comprising:
an absorbent liquid heat exchanger that is configured to perform heat exchange between the rich liquid flowing through the rich line and the lean liquid flowing through the lean line to heat the rich liquid and cool the lean liquid,
wherein the coalescer separates the hydrocarbons from the rich liquid obtained before being discharged from the absorption tower and being supplied to the absorbent liquid heat exchanger, by the oil-water separation.

8. The acidic gas recovery system according to claim 1,
wherein a plurality of the inlet adsorption devices are connected to the cooling tower and the absorption tower in parallel with each other.

9. An acidic gas recovery system comprising:
an absorption tower into which a target gas of treatment containing an acidic gas as a recovery target gas is introduced, and that is configured to bring the target gas of treatment into contact with an absorbent liquid to discharge the absorbent liquid which has absorbed the acidic gas and an absorption tower discharge gas containing the target gas of treatment from which the acidic gas is removed;
a regeneration tower that is configured to release the acidic gas from the absorbent liquid discharged from the absorption tower to discharge the absorbent liquid from which the acidic gas is released and a regeneration tower discharge gas containing the acidic gas;
a gas-liquid separator that is configured to separate moisture contained in the regeneration tower discharge gas discharged from the regeneration tower to discharge separated discharge gas from which the moisture is separated and supply the separated moisture to the regeneration tower as drain water;
a dewatering device that is configured to absorb the moisture contained in the regeneration tower discharge gas discharged from the regeneration tower; and
a drain water adsorption device that is configured to bring the drain water supplied from at least one of the gas-liquid separator and the dewatering device to the regeneration tower into contact with activated carbon to remove hydrocarbons remaining in the drain water.

10. The acidic gas recovery system according to claim 9,
wherein the drain water adsorption device brings the drain water discharged from the gas-liquid separator into contact with the activated carbon.

11. The acidic gas recovery system according to claim 9,
wherein the drain water adsorption device brings the drain water discharged from the dewatering device into contact with the activated carbon.

12. The acidic gas recovery system according to claim 9,
wherein the drain water adsorption device supplies the drain water brought into contact with the activated carbon to the regeneration tower.

13. The acidic gas recovery system according to claim 9,
wherein the absorption tower includes
a recovery section that is configured to bring the target gas of treatment into contact with the absorbent liquid to cause the absorbent liquid to recover the acidic gas, and
a water washing section that is configured to bring a decarbonized gas obtained after being brought into contact with the absorbent liquid in the recovery section into contact with washing water to recover an absorbent liquid component accompanied in the decarbonized gas, and
the drain water adsorption device that is configured to supply the drain water brought into contact with the activated carbon to the water washing section.

14. The acidic gas recovery system according to claim 9, further comprising:
an outlet adsorption device that is configured to bring the regeneration tower discharge gas discharged from the regeneration tower into contact with activated carbon to remove the hydrocarbons remaining in the regeneration tower discharge gas.

15. The acidic gas recovery system according to claim 9, further comprising:
a rich line that is configured to supply a rich liquid which is the absorbent liquid which has absorbed the acidic gas from the absorption tower to the regeneration tower;
a lean line that is configured to supply a lean liquid which is the absorbent liquid from which the acidic gas is released from the regeneration tower to the absorption tower; and
a coalescer that is configured to separate the hydrocarbons from the rich liquid or the lean liquid by oil-water separation.

16. The acidic gas recovery system according to claim 15, further comprising:
an absorbent liquid heat exchanger that is configured to perform heat exchange between the rich liquid flowing through the rich line and the lean liquid flowing through the lean line to heat the rich liquid and cool the lean liquid,
wherein the coalescer separates the hydrocarbons from the rich liquid obtained before being discharged from the absorption tower and being supplied to the absorbent liquid heat exchanger, by the oil-water separation.

17. An acidic gas recovery system comprising:
an absorption tower into which a target gas of treatment containing an acidic gas as a recovery target gas is introduced, and that is configured to bring the target gas of treatment into contact with an absorbent liquid to discharge the absorbent liquid which has absorbed the acidic gas and an absorption tower discharge gas containing the target gas of treatment from which the acidic gas is removed;
a regeneration tower that is configured to release the acidic gas from the absorbent liquid discharged from the absorption tower to discharge the absorbent liquid from which the acidic gas is released and a regeneration tower discharge gas containing the acidic gas;
a dewatering device that is configured to absorb moisture contained in the regeneration tower discharge gas discharged from the regeneration tower; and
an outlet adsorption device that is configured to bring the regeneration tower discharge gas from which the moisture is removed in the dewatering device into contact with activated carbon to remove hydrocarbons remaining in the regeneration tower discharge gas.
